(19) United States
(12) Patent Application Publication
(10) Pub. No.: US 2012/0172058 A1
(43) Pub. Date: Jul. 5, 2012

(54) Tracking and Alerting Populations Using Wireless, Wireline and Internet Mechanisms

(75) Inventor: Gerard P. O'Reilly, Manalapan, NJ (US)

(73) Assignee: LGS INNOVATIONS LLC, Florham Park, NJ (US)

(21) Appl. No.: 12/984,020

(22) Filed: Jan. 4, 2011

(51) Int. Cl. H04W 24/00

(52) U.S. Cl. 455/456.3

(57) ABSTRACT

A method and system for transmitting alerts messages is provided. An automatic management system determines a location of a device. An alerting device is determined based on the determined location and an alert message is transmitted to the alerting device.

### FIELD OF THE INVENTION

The present invention is generally directed to systems and methods for transmitting alerts and more particularly to transmitting automatic alerts based on the location of communication devices.

### BACKGROUND

During times of emergency (e.g., natural disaster, accident, or terrorist attack), emergency workers, government officials, and certain VIPs or industry individuals may access the Government Emergency Telecommunications Service (GETS) and the Wireless Priority Service (WPS) in order to contact their respective organizations. GETS and WPS are communication networks that allow users to complete calls at a higher priority level when normal communication methods, such as the public switched telephone network are experiencing congestion. However, the aforementioned parties that utilize these systems would only contact their respective organizations using GETS and WPS after being alerted to an emergency situation via television, radio, incoming call, or data message. Without knowledge of an emergency situation, the aforementioned parties would rely on conventional communication methods instead of invoking their ability to communicate through GETS and WPS.

Certain specialized alerting systems allow users to sign up to specialized networks where alert messages may be transmitted via telephone calls or data messages. However, individual users typically have two or more telephone lines (e.g., home, work, mobile) and two or more different telephone numbers where they can be contacted. Additionally, individual users may have several associated internet addresses where they can be contacted as well. Thus, current alerting systems are inefficient and not completely effective in ensuring that alert messages are properly delivered to users. For example, if an alert message is not delivered to one of the parties discussed above in the context of an emergency situation that party would not know to use GETS or WPS to ensure a higher priority communication level.

### SUMMARY

In accordance with an embodiment of the invention, a method and system for transmitting alert messages is provided. An automatic management system determines a location of a user device. An alerting device is determined based on the determined location and an alert message is transmitted to the alerting device.

In an embodiment, location information received from the device is analyzed to determine the location of the device.

In an embodiment, the alerting device is determined based on the determined location by correlating the determined location with at least one fixed location based on subscriber profile information associated with the user device, and determining the alerting device based on the correlation. The alerting device may be determined to be the user device or a communication device associated with a fixed location.

In an embodiment, the subscriber profile information includes parameters specifying certain types of alert messages to transmit.

These and other advantages of the embodiments described will be apparent to those of ordinary skill in the art by reference to the following detailed description and the accompanying drawings.

### BRIEF DESCRIPTION OF THE DRAWINGS

FIG. 1 shows an exemplary diagram detailing the interaction between an automatic management system, an emergency operations center, and various devices in accordance with an embodiment of the present invention;

FIG. 2 shows an exemplary diagram detailing the contents of subscriber profile information associated with an end user device in accordance with an embodiment of the invention;

FIG. 3 shows a flowchart of a method for transmitting an alert to a communication device in accordance with an embodiment of the invention; and

FIG. 4 shows a high level block diagram of a computer system which may be used to implement certain embodiments of the invention.

### DETAILED DESCRIPTION

The embodiments described herein provide systems and methods for transmitting alert messages to end user devices based on the location of the end user devices. Transmitting alert messages based on location ensures that emergency service workers or government officials become aware of an emergency situation as quickly as possible. Additionally, the systems and methods described herein may be used on a larger scale to transmit alert messages to individuals who want to be notified of specific circumstances, such as financial situations, legal situations, and retail or wholesale buying opportunities.

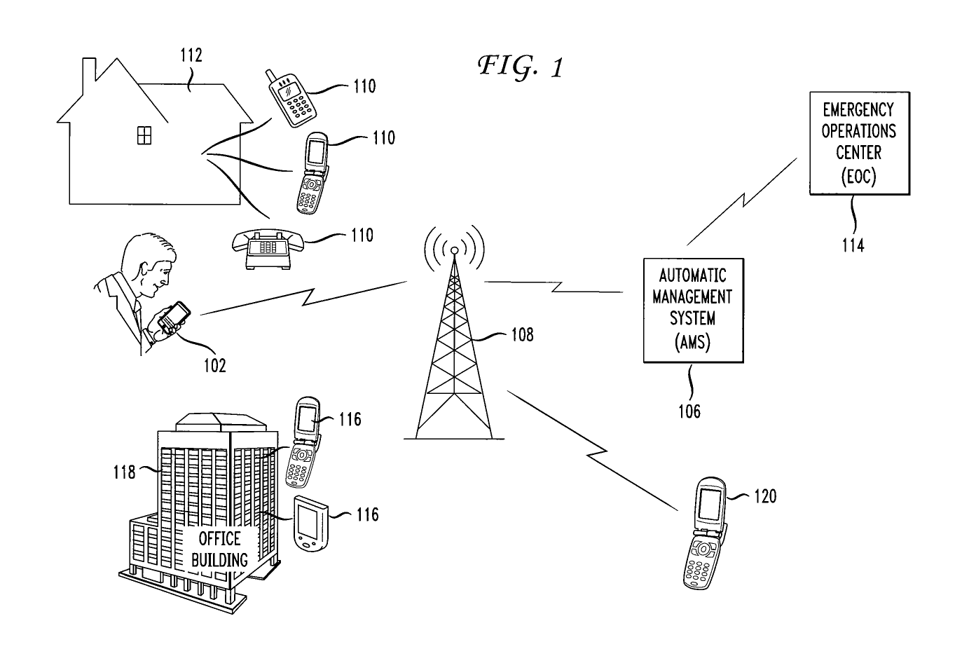

FIG. 1 shows an exemplary diagram detailing the interaction between an automatic management system 106, an emergency operations center 114, and various devices in accordance with an embodiment of the present invention. An end user device 102 may determine its location based on communication with a global positioning system (GPS) satellite. This location information includes information regarding the current geographical position of end user device 102. The location information may also include information regarding the past geographical position of end user device 102, information regarding whether end user device 102 is stationary, and information regarding the direction in which end user device 102 is traveling if not stationary.

End user device 102 may communicate with automatic management system 106 through service provider 108 based upon subscriber profile information associated with end user device 102. The subscriber profile information may be stored at a database within automatic management system 106 or at a database within service provider 108. Each database may include several components, all of which may be searched to find specific subscriber profile information associated with end user device 102. The subscriber profile information may also include alert message forwarding parameters which may be invoked if the user of end user device 102 determines that certain alert messages should be forwarded to other parties. For example, a manager may specify within the subscriber profile information that certain alert messages be transmitted to a cell phone, office phone, or home phone of an employee in the event that this employee is not subscribed to the particular alert messages.

Service provider 108 may also detect end user devices, such as end user device 102 within service provider 108's serving area and notify automatic management system 106 that end user device 102 is capable of receiving an alerting message.

The subscriber profile information includes alerting parameters associated with end user device 102 and a user of end user device 102, such as parameters instructing automatic management system 106 to send alert messages to end user device 102 and/or communication devices associated with a fixed location. For example, FIG. 1 shows communication devices 110 associated with a fixed location, (home 112) and communication devices 116 associated with another fixed location, (office 118).

The parameters may include conditional statements indicating which fixed location automatic management system 106 should send alert messages to. For example, alert messages may be sent to end user device 102 even if end user device 102 is located in the same location as a fixed location such as home 112 and office 118. A user may modify or update subscriber profile information through end user device 102 via communication with service provider 108 or automatic management system 106. Specifically, a user may update the subscriber profile information to instruct automatic management system 106 to transmit only certain types of alert messages instead of all alert messages. Although only communication devices 110 and 116 associated with fixed locations home 112 and office 118, respectively, are shown in FIG. 1, it is understood that the subscriber profile information may include parameters for any number of communication devices associated with any number of fixed locations.

If subscriber profile information associated with end user device 102 includes parameters instructing automatic management system 106 to send alert messages, then end user device 102 may transmit the location information to automatic management system 106. Automatic management system 106 may receive alert messages from emergency operations center 114. Automatic management system 106 analyzes the location information of end user device 102 and correlates the location information with the location of one or more fixed locations such as home 110 or office 116 in order to determine which devices to send the alert message to for ensuring the highest likelihood that the alert message will be received.

If, for example, end user device 102 is not located within the vicinity of a fixed location such as home 112 and office 118, then automatic management system 106 may transmit an alert message to the end user device 102 only. If, for example, end user device 102 is determined to be heading towards a fixed location or is already at the fixed location, such as home 102, then automatic management system 106 may transmit an alert message to one or all of communication devices 110 based on subscriber profile information. This is particularly advantageous if end user device 102 is a mobile phone that is set to vibrate when receiving incoming calls or data messages. Even if a user is in the home, the user may not check their mobile phone and may be more easily reachable through one of communication devices 110. Automatic management system 106 may also transmit the alert message to end user device 102 to further ensure that the alert message is received. Upon successful receipt of the alert, end user device 102 and/or communication devices 110 may send an acknowledgement message to automatic management system 106.

Automatic management system 106 may also determine that an alert should be transmitted to backup communication device 120 based on subscriber profile information. This may be useful in situations where end user device 102 is not configured to receive alert messages or if acknowledgement messages are not received from end user device 102 and/or communication devices 110.

A communication device, end user device, and ancillary device, as described herein may be, but are not limited to, a mobile phone, personal digital assistant (PDA), laptop computer, landline based telephone, or desktop computer. While the exemplary diagram of FIG. 1 shows one end user device 102, multiple end user devices may be configured to communicate with automatic management system 106 as described herein. End user device 102, communication devices 110 and 112, and backup communication device 120 are all configured to communicate using a wire line network, wireless network, or through the Internet. Thus alert messages may be transmitted for example as telephone or mobile phone calls and/or data messages.

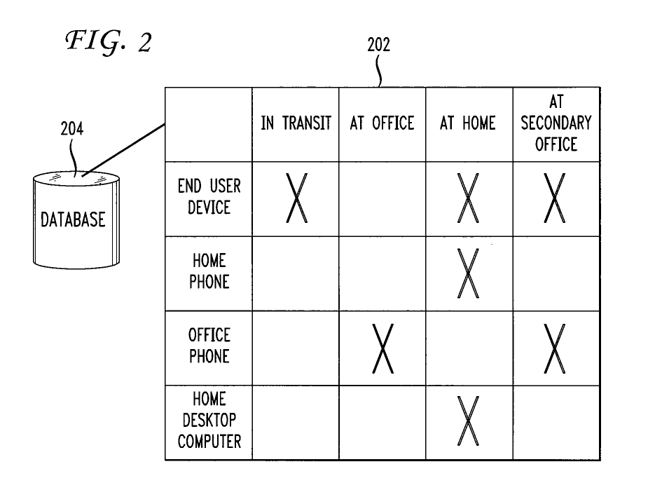

FIG. 2 shows an exemplary diagram detailing the contents of subscriber profile information associated with end user device 102. Subscriber profile information 202 may be stored on a database 204 within automatic management system 106 or service provider 108. For example, based on the exemplary subscriber profile information shown in FIG. 2, if the location of end user device 102 is “in transit”, then automatic management system 106 will attempt to send alert messages to end user device 102. If the location of end user device 102 is “at office”, then automatic management system 106 will attempt to send alert messages to an “office phone.” If the location of end user device 102 is “at home”, then automatic management system 106 will attempt to send alert messages to end user device 102, “home phone” and “home desktop computer.” If the location of end user device 102 is at “secondary office” then automatic management system 106 will attempt to send alert messages to end user device 102 and “office phone.” It is understood that the subscriber profile information 202 shown in FIG. 2 is exemplary and may vary based on different end user devices and users of end user devices. Additionally, the categories shown within subscriber profile information 202 may vary depending on which end user device it is associated with.

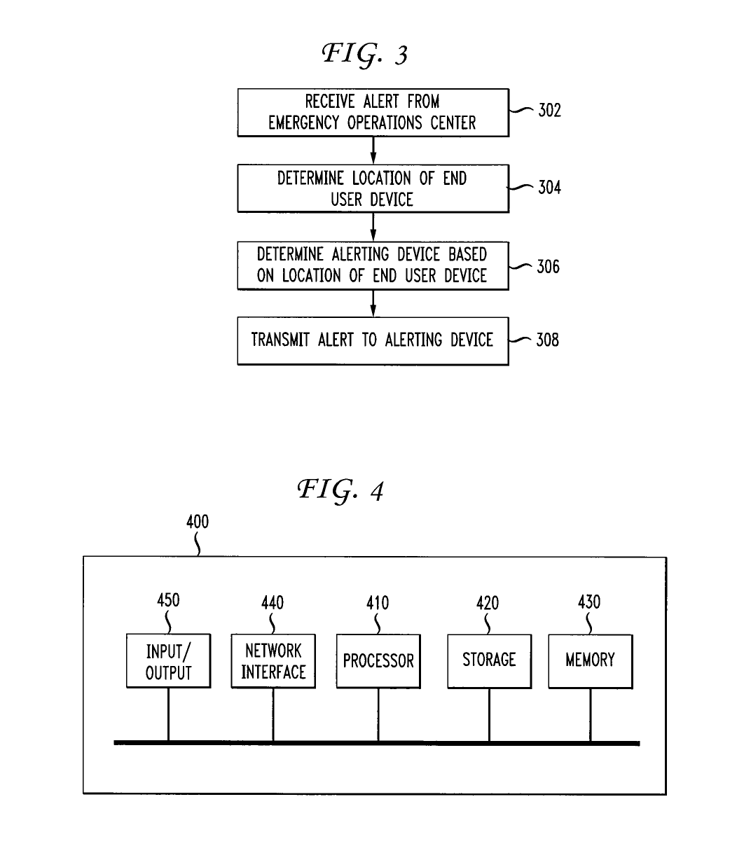

FIG. 3 shows a flowchart of a method for transmitting an alert to a communication device in accordance with an embodiment of the invention. At step 302, automatic management system 106 receives an alert message from emergency operations center 114. Based on subscriber profile information associated with an end user device such as end user device 102, automatic management system 106 determines whether transmitting the alert message is appropriate.

At step 304, automatic management system 106 determines the location of end user device 102. Location information is transmitted from end user device 102 to automatic management system 106. Automatic management system 106 analyzes the location information to determine the current geographical position of end user device 102 and whether end user device 102 is stationary or in transit.

At step 306, automatic management system 106 determines an alerting device based on the location. By correlating the current geographical position of end user device 102 with the location of one or more fixed location associated with a user of end user device 102, such as home 112 or office 118, automatic management system 106 determines an alerting device to send an alert message to. Based on the correlation discussed above, automatic management system 106 may determine that the alerting device is end user device 102 and/or communication devices 110 associated with fixed location, home 112.

At step 308, automatic management system 106 transmits the alert to the determined alerting device. If no acknowledgement is received by automatic management system 106 from the alerting device, automatic management system 106 may attempt retransmission after a set time interval or alternatively attempt transmission of the alert to backup communication device 120 as described above.

The above-described methods for transmitting alerts can be implemented on a computer using well-known computer processors, memory units, storage devices, computer software, and other components. A high-level block diagram of such a computer is illustrated in FIG. 4. Computer 400 contains a processor 410 which controls the overall operation of computer 400 by executing computer program instructions which define such operations. The computer program instructions may be stored in a storage device 420, or other computer readable medium (e.g., magnetic disk, CD ROM, etc.), and loaded into memory 430 when execution of the computer program instructions is desired.

Thus, the method steps of FIG. 3 can be defined by the computer program instructions stored in the memory 430 and/or storage 420 and controlled by the processor 410 executing the computer program instructions. For example, the computer program instructions can be implemented as computer executable code programmed by one skilled in the art to perform an algorithm defined by the method steps of FIG. 3. Accordingly, by executing the computer program instructions, the processor 410 executes an algorithm defined by the method steps of FIG. 3.

While computer 400 has been described as being used for transmitting alert messages to end user devices in accordance with the method steps shown in FIG. 3, computer 400 may also perform functionalities related to those described above in connection with the other Figures. Computer 400 also includes one or more network interfaces 440 for communicating with other devices via a network. Computer 400 further includes input/output devices 450 that enable user interaction with the computer 400 (e.g., display, keyboard, mouse, speakers, buttons, etc.) One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive, and the scope of the embodiments disclosed herein is not to be determined from the Detailed Description, but rather from the claims as interpreted according to the full breadth permitted by the patent laws. It is to be understood that the embodiments shown and described herein are only illustrative of the principles of the present embodiments and that various modifications may be implemented by those skilled in the art without departing from the scope and spirit of the embodiments described herein. Those skilled in the art could implement various other feature combinations without departing from the scope and spirit of the embodiments of the present disclosure.

I claim:

1. A method for transmitting alert messages comprising:
determining a location of a user device;
determining an alerting device based on the determined location; and
transmitting an alert message to the alerting device.

2. The method of claim 1, wherein determining the location of the device comprises:
analyzing location information received from the device.

3. The method of claim 1, wherein determining an alerting device based on the determined location comprises:
correlating the determined location with at least one fixed location based on subscriber profile information associated with the user device; and
determining the alerting device based on the correlation.

4. The method of claim 3, wherein the alerting device is the user device.

5. The method of claim 3, wherein the alerting device is a communication device associated with a fixed location.

6. The method of claim 3, wherein the subscriber profile information includes parameters specifying certain types of alert messages to transmit.

7. A system for transmitting alert messages comprising:
means for determining a location of a user device;
means for determining an alerting device based on the determined location; and
means for transmitting an alert message to the alerting device.

8. The system of claim 7, wherein means for determining the location of the device comprises:
means for analyzing location information received from the device.

9. The system of claim 7, wherein means for determining an alerting device based on the determined location:
means for correlating the determined location of the user device with at least one fixed location based on subscriber profile information associated with the user device; and
means for determining the alerting device based on the correlation.

10. The system of claim 9, wherein the alerting device is the user device.

11. The system of claim 9, wherein the alerting device is a communication device associated with a fixed location.

12. The system of claim 9, wherein the subscriber profile information includes parameters specifying certain types of alert messages to transmit.

13. A computer readable medium storing computer program instructions which, when executed on a processor, define the steps of:
determining a location of a user device;
determining an alerting device based on the determined location; and
transmitting an alert message to the alerting device.

14. The computer readable medium of claim 13, wherein determining the location of the device comprises:
analyzing location information received from the user device.

15. The computer readable medium of claim 13, wherein determining an alerting device based on the determined location comprises:
correlating the determined location of the user device with at least one fixed location based on subscriber profile information associated with the user device; and
determining the alerting device based on the correlation.

16. The computer readable medium of claim 15, wherein the alerting device is the user device.

17. The computer readable medium of claim 15, wherein the alerting device is a communication device associated with a fixed location.

18. The computer readable medium of claim 15, wherein the subscriber profile information includes parameters specifying certain types of alert messages to transmit.
